(19) United States
(12) Patent Application Publication
(10) Pub. No.: US 2015/0287032 A1
(43) Pub. Date: Oct. 8, 2015

(54) METHODS AND SYSTEMS FOR CONNECTING MULTIPLE MERCHANTS TO AN INTERACTIVE ELEMENT IN A WEB PAGE

(71) Applicant: MasterCard International Incorporated, Purchase, NY (US)

(72) Inventor: Michael J. FRIEDMAN, Stamford, CT (US)

(73) Assignee: MasterCard International Incorporated, Purchase, NY (US)

(21) Appl. No.: 14/744,528

(22) Filed: Jun. 19, 2015

Related U.S. Application Data
(62) Division of application No. 13/565,088, filed on Aug. 2, 2012.
(60) Provisional application No. 61/665,149, filed on Jun. 27, 2012.

(51) Int. Cl. G06Q 20/40

(52) U.S. Cl. CPC G06Q 20/40

(57) ABSTRACT

A method for redirecting a user apparatus to a merchant web page includes: transmitting web page data corresponding to a web page to be displayed on a user apparatus, the web page includes at least one interactive element; receiving an indication of a user interaction with an interactive element; storing, a plurality of merchant data entries, each entry including a merchant web page, an indication of interest, and an associated interactive element; identifying, a subset of the plurality of data entries, wherein each entry in the subset is associated with the interactive element; identifying, in the subset, a single entry based on the indication of interest of each entry in the subset; and transmitting redirecting data to redirect the user apparatus to the merchant web page associated with the single entry.

### RELATED APPLICATIONS

This application claims the priority benefit of prior-filed U.S. Provisional Application No. 61/665,149, filed Jun. 27, 2012, and U.S. Non-Provisional application Ser. No. 13/565,088, filed Aug. 2, 2012 for “Methods and Systems for Connecting Multiple Merchants to an Interactive Element in a Web Page,” by Michael Friedman, each of which is herein incorporated by reference in its entirety.

### FIELD

The present disclosure relates to connecting multiple merchants to an interactive element displayed on a web page, specifically by redirecting a user and processing financial transactions based on merchant indications of interest to associated interactive elements.

### BACKGROUND

Current methods for advertising on web pages may include the display of a randomly selected advertisement in predetermined advertising space on the web page. This can result in a web page that is different each time a user visits the web page, specifically the advertisement that is displayed. If an advertisement does not fit the style or aesthetic of the web page, it can become unattractive to the user, resulting in their ignoring the advertisement or that entire area of the web page altogether. The same problem persists with products offered for purchase from a randomly selected merchant. The continually changing area may be a distraction to the user and result in lower sales for each merchant. In addition, products available for purchase from a website, where the products are available through an entity other than the web site provider/owner, may typically redirect the user to the product provider's web page. This may deter some users, who desire to purchase the product from the web page they have visited. This can result in a loss of sales for the advertising merchant and a loss of commission revenue for the hosting web page provider.

In addition, when displaying merchant advertisements and displaying products available for purchase from third party merchants and retailers, some web pages may select a merchant randomly or based on merchant performance factors, such as consumer feedback, fulfillment efficiency, etc. Such systems may leave merchants without a history with the particular web page at a disadvantage, as they may lack sufficient history to be featured on the web page as a product provider or advertiser. Alternatively, some web pages provide a list of multiple third party merchants and retailers from which a user can purchase a product. Some consumers may be overwhelmed by the number of available merchants and may be dissuaded from purchasing the product due to the difficulty in selecting a merchant with whom to transact. Hence, there is a technical problem of presenting this product information when offered by multiple merchants in a way that does not create disincentives to potential customers.

Thus, there is a perceived opportunity to improve the technology of connecting of multiple merchants to interactive elements on a web page by displaying an interactive element native to the web page and associating, as a technical solution, the element with a merchant based on data representing or indicating a degree of interest of a plurality of merchants.

### SUMMARY

The present disclosure provides a description of methods and systems for connecting multiple merchants to an interactive element on a web page.

A method for redirecting a user apparatus to a merchant web page includes: transmitting, by a transmitter, web page data corresponding to a web page to be displayed on a user apparatus, wherein the web page includes at least one interactive element; receiving, by a receiver, an indication of a user interaction with an interactive element included in the at least one interactive element; storing, in a database, a plurality of merchant data entries, wherein each merchant data entry includes at least a merchant web page, an indication of interest, and an associated interactive element; identifying, in the database, a subset of the plurality of merchant data entries, wherein each merchant data entry in the subset of the plurality of merchant data entries is associated with the interactive element; identifying, in the subset of the plurality of merchant data entries, a single merchant data entry based on the indication of interest of each merchant data entry in the subset of the plurality of merchant data entries; and transmitting, by the transmitter, redirecting web page data to redirect the user apparatus to the merchant web page associated with the single merchant data entry. Alternatively, a purchase can be made by receiving information through the advertising webpage.

A method for processing a financial transaction includes: storing, in a database, a plurality of merchant data entries, where each merchant data entry includes at least a merchant identifier, a product identifier, and an indication of interest; receiving, via a web page, an authorization request for a financial transaction, wherein the authorization request includes at least a consumer and a product identification; identifying, in the database, a subset of the plurality of merchant data entries, wherein, for each merchant data entry in the subset of the plurality of merchant data entries, the associated product identifier corresponds to the received product identification; identifying, from the subset of the plurality of merchant data entries, a single merchant data entry based on the associated indication of interest of each merchant data entry in the subset of the plurality of merchant data entries; processing, by a processor the financial transaction including the consumer and a merchant associated with the single merchant data entry; and transmitting, by a transmitter, transaction data of the financial transaction to the merchant associated with the single merchant data entry.

A system for redirecting a user apparatus to a merchant web page includes a transmitter, a receiver, a database, and a processor. The transmitter is configured to transmit web page data corresponding to a web page to be displayed on a user apparatus, wherein the web page includes at least one interactive element. The receiver is configured to receive an indication of a user interaction with an interactive element included in the at least one interactive element. The database is configured to store a plurality of merchant data entries, wherein each merchant data entry includes at least a merchant web page, an indication of interest, and an associated interactive element. The processor is configured to identify, in the database, a subset of the plurality of merchant data entries, wherein each merchant data entry in the subset of the plurality of merchant data entries is associated with the interactive element; and identify, in the subset of the plurality of merchant data entries, a single merchant data entry based on the indication of interest of each merchant data entry in the subset of the plurality of merchant data entries. The transmitter is further configured to transmit redirecting web page data to redirect the user apparatus to the merchant web page associated with the single merchant data entry.

A system for processing a financial transaction includes a database, a receiver, a processor, and a transmitter. The database is configured to store a plurality of merchant data entries, where each merchant data entry includes at least a merchant identifier, a product identifier, and an indication of interest. The receiver is configured to receive an authorization request for a financial transaction, wherein the authorization request includes at least a consumer identification and a product identification. The processor is configured to: identify, in the database, a subset of the plurality of merchant data entries, wherein, for each merchant data entry in the subset of the plurality of merchant data entries, the associated product identifier corresponds to the received product identification; identify, from the subset of the plurality of merchant data entries, a single merchant data entry based on the associated indication of interest of each merchant data entry in the subset of the plurality of merchant data entries; and process the financial transaction including the consumer and a merchant associated with the single merchant data entry. The transmitter is configured to transmit transaction data of the financial transaction to the merchant associated with the single merchant data entry.

### BRIEF DESCRIPTION OF THE DRAWING FIGURES

Exemplary embodiments are best understood from the following detailed description when read in conjunction with the accompanying drawings. Included in the drawings are the following figures:

FIG. 1 is a block diagram illustrating a system for connecting multiple merchants to an interactive element on a web page in accordance with exemplary embodiments.

FIG. 2 is a block diagram illustrating a web page processing server for use in the system of FIG. 1 in accordance with exemplary embodiments.

FIG. 3 is a block diagram illustrating a dataset of a merchant web database in accordance with exemplary embodiments.

FIG. 4 is a block diagram illustrating a dataset of a merchant product database in accordance with exemplary embodiments.

FIG. 5 is an illustration of a web page including interactive elements connected to multiple merchants in accordance with exemplary embodiments.

FIGS. 6A and 6B are illustrations of tables of merchant data entries corresponding to the interactive elements of FIG. 5 in accordance with exemplary embodiments.

FIG. 7 is a flow chart illustrating a method for connecting multiple merchants to an interactive element on a web page and processing user interactions in accordance with exemplary embodiments.

FIG. 8 is a block diagram illustrating exemplary computer system architecture for use in the systems of FIG. 1 in accordance with exemplary embodiments.

FIG. 9 is a flow chart illustrating an exemplary method for redirecting a user apparatus to a merchant web page in accordance with exemplary embodiments.

FIG. 10 is a flow chart illustrating an exemplary method for processing a financial transaction in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### System for Connecting Multiple Merchants to an Interactive Element

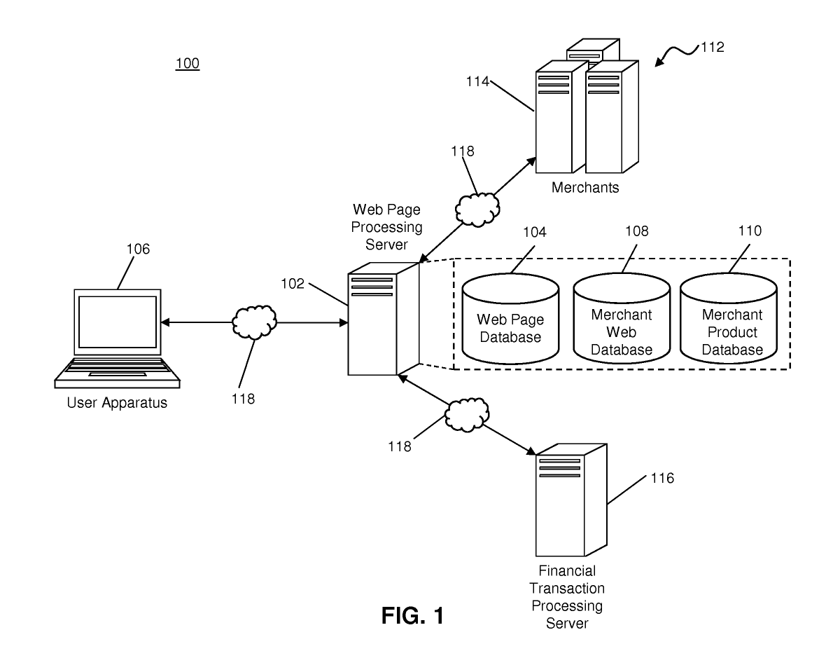

FIG. 1 illustrates a system 100 for connecting multiple merchants to an interactive element displayed on a web page.

The system 100 may include a web page processing server 102. The web page processing server 102 may include a web page database 104 configured to store web page data. Types and formats of web page data stored in the web page database 104 suitable for performing functions as disclosed herein will be apparent to persons having skill in the relevant art. The web page processing server 102 may host a web page stored in the web page database 104 for display on a user apparatus 106.

The user apparatus 106 may be any apparatus suitable for the display of a web page, such as a desktop computer, a laptop computer, a netbook, a tablet computer, a slate computer, a smartphone, etc. The web page displayed on the user apparatus 106 may include a plurality of interactive elements that a user of the user apparatus 106 may interact with. Interactive elements may include hyperlinks, images, videos, audio sounds, animated elements (e.g., including avatars), or any other type of element with which a user may interact through any type of input device as will be apparent to persons having skill in the relevant art. Input devices for interacting with an interactive element displayed on the web page may include a keyboard, a mouse, a microphone, a finger capacitive touch display, a stylus, etc.

When a user of the user apparatus 106 interacts with an interactive element, an indication of the user interaction may be transmitted to the web page processing server 102. In one embodiment, the user may interact with an interactive element configured to redirect the user apparatus 106 to another web page. In such an embodiment, the web page processing server 102 may identify a merchant 114 of a plurality of merchants 112 based on merchant data entries in a merchant web database 108, discussed in more detail below. Methods for selecting one of a number of multiple merchants for the redirection of a user to a merchant web page will be discussed in more detail below.

In other embodiments, the user may interact with an interactive element configured to initiate a financial transaction. In such an embodiment, the web page processing server 102 may select a merchant 114 from the plurality of merchants 112 to participate in the transaction. The web page processing server 102 may select the merchant 114 based on indications of interest of each of the merchants 112 as stored in a merchant product database 110, to be discussed in more detail below. Upon selecting the merchant 114, the web page processing server 102 may initiate a financial transaction with the user apparatus 106 and then transmit an authorization request to a financial transaction processing server 116 for authorization of the transaction. Once a response has been received from the financial transaction processing server 116, the web page processing server 102 may notify the user apparatus 106 and/or the merchant 114 of the approval or denial of the transaction.

Each of the web page processing server 102, user apparatus 106, merchants 112, and financial transaction processing server 116 may be configured to communicate via a network 118. The network 118 may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. Each of the web page database 104, merchant web database 108, and merchant product database 110 may be included as part of the web page processing server 102, or may be external to the web page processing server 102 and accessed via the network 118.

### Web Page Processing Server

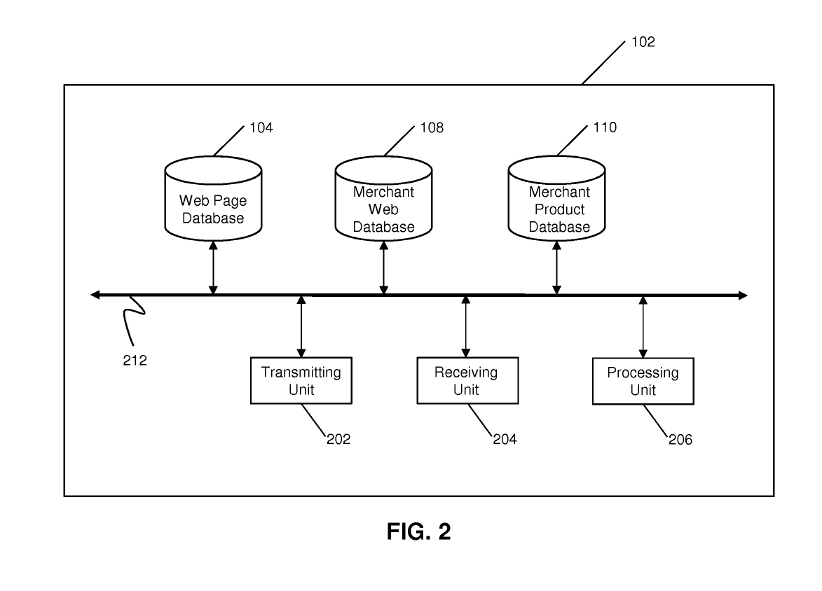

FIG. 2 is a block diagram illustrating an embodiment of the web page processing server 102. The web page processing server 102 may include the web page database 104, the merchant web database 108, the merchant product database 110, a transmitting unit 202, a receiving unit 204, and a processing unit 206. Each of the components may be communicate via a bus 212. Suitable types and configurations of the bus 212 will be apparent to persons having skill in the relevant art.

Data stored in the web page database 104, merchant web database 108, or merchant product database 110 (the “databases”) may be stored on any type of suitable computer readable media, such as optical storage (e.g., a compact disc, digital versatile disc, blu-ray disc, etc.) or magnetic tape storage (e.g., a hard disk drive). The databases may be configured in any type of suitable database configuration, such as a relational database, a structured query language (SQL) database, a distributed database, an object database, etc. Suitable configurations and database storage types will be apparent to persons having skill in the relevant art. The databases may each be a single database, or may comprise multiple databases which may be interfaced together (e.g., physically or via a network, such as the network 118).

The transmitting unit 202 may be configured to transmit web page data (e.g., and stored in the web page database 104) for a web page including at least one interactive element to a user apparatus, such as the user apparatus 106. Methods for transmitting (e.g., hosting) a web page will be apparent to persons having skill in the relevant art. The receiving unit 204 may be configured to receive an indication of a user interaction with the at least one interactive element.

The processing unit 206 may be configured to identify, in the merchant web database 108 or the merchant product database 110, a plurality of merchant data entries, discussed in more detail below, associated with the interacted interactive element. The processing unit 206 may also be configured to identify a single merchant data entry in the plurality of merchant data entries based on associated indications of interest, also discussed in more detail below. Further, if for any reason selected merchant is not appropriate for a particular transaction (e.g. due to lack of stock, being unavailable for order completion for any reason, because of user de-selection or selection of preferred merchants, etc.), a merchant with a different indication of interest might be selected for display.

In some embodiments, the processing unit 206 may be further configured to process a financial transaction. In alternative embodiments, the transmitting unit 202 may be configured to transmit an authorization request for a financial transaction, and the receiving unit 204 may be configured to receive a response to the authorization request. The transmitting unit 202 may be further configured to transmit a notification of a processed and/or authorized financial transaction to the user apparatus 106 and/or the merchant 114. Suitable types of notifications will be apparent to persons having skill in the relevant art, such as redirecting the user apparatus 106 to a notification web page, transmitting an electronic mail, etc.

### Dataset Configuration and Indications of Interest

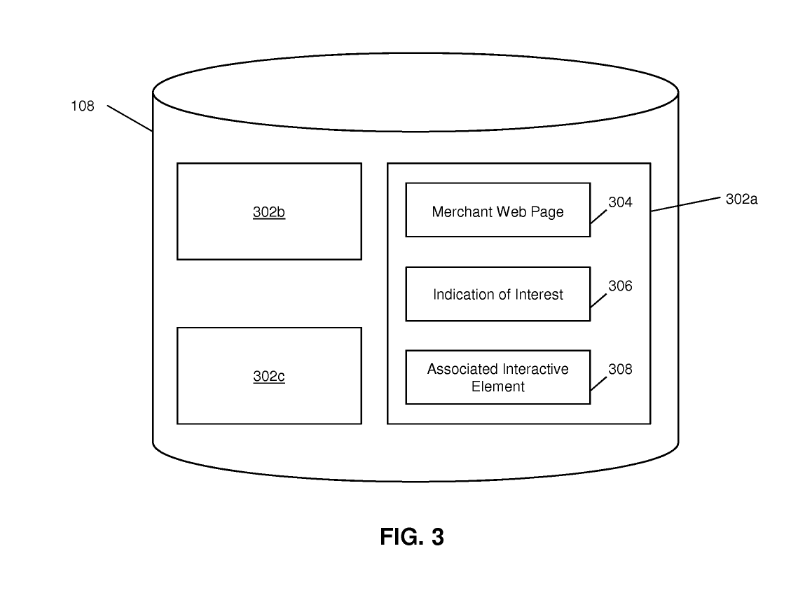

FIG. 3 is an illustration of data in the merchant web database 108. The merchant web database 108 may include a plurality of merchant web data entries 302 (e.g., merchant web data entries 302a, 302b, and 302c as illustrated). Each merchant web data entry 302 may include a merchant web page 304, an indication of interest 306, and an associated interactive element 308.

The merchant web page 304 may be a web page associated with a merchant for use in redirecting the user apparatus 106 upon the receipt of an indication of a user interaction with an associated interactive element, as discussed in more detail below. In one embodiment, the merchant web page 304 may be a uniform resource locator (URL) for a web page. In another embodiment, the merchant web page 304 may be web page code, such as JavaScript, configured to redirect the user apparatus 106 to a particular web page (e.g., defined by a URL). Other suitable values for the merchant web page 304 will be apparent to persons having skill in the relevant art.

The associated interactive element 308 may be a value or identifier corresponding to an interactive element displayed by a web page. Suitable types of values or identifiers for use as a value of the associated interactive element 308 in the merchant web data entry 302 may depend on the type of interactive element associated and/or the type of web page on which the associated interactive element is displayed. For example, if a web page uses hypertext markup language (HTML) and the interactive element is an image or a hyperlink, the associated interactive element 308 may be a unique identification value assigned to the interactive element in the corresponding HTML tag. Other suitable methods for identifying the associated interactive element 308 will be apparent to persons having skill in the relevant art.

The indication of interest 306 may be a value indicating the interest of the associated merchant in the associated interactive element 308. In an exemplary embodiment, the indication of interest 306 may be a numerical value, token, grade, or indicia indicating the relative ranking of the associated merchant. In a further embodiment, the indication of interest 306 may be a percentage, numerical value generated by an algorithm (e.g., which may take into account additional factors), or a cryptogram. The indication of interest 306 may (e.g., if the value is a percentage) be the relative interest of the associated merchant in the associated interactive element 308, and may be used to indicate the probability that the particular merchant web data entry 302 may be selected once a user indication indicating the associated interactive element 308 has been received by the web page processing server 102.

For example, a first merchant web data entry 302a may include an indication of interest 306 of 76%, and a second merchant web data entry 302b may include an indication of interest 306 of 24%. Upon receiving an indication of a user interaction with the interactive element 308 associated with each of the two merchant web data entries 302a and 302b, the processing unit 206 may identify one of the two merchant web data entries 302a and 302b based on the indications of interest 306. Accordingly, the user apparatus 106 may be redirected to the merchant web page 304 of the merchant web data entry 302a 76 times out of 100, while the user apparatus 106 may be redirected to the merchant web page 304 of the merchant web data entry 302b the other 24 times out of 100.

Methods of identifying a single merchant web data entry 302 will be apparent to persons having skill in the relevant art and may vary depending on the value of the indication of interest 306 and the application. For example, if the indication of interest 306 is represented by a percentage, the processing unit 206 may apportion the percentages of each merchant web data entry 302 in a subset of merchant web data entries corresponding to an indicated associated interactive element 308 to a range of numbers between 1 and 100, and generate a random number between 1 and 100. The merchant web data entry 302 whose apportioned range includes the generated random number may be identified, and the user apparatus 106 redirected to the corresponding merchant web page 304.

In an exemplary embodiment, the corresponding merchant 114 may submit a financial bid as an indication of interest in being the target of a redirection initialized by a user interaction with a particular associated interactive element 308. For example, a first merchant 114 may bid $5,000 on a particular associated interactive element 308 and a second merchant 114 may bid $2,000 on the same associated interactive element 308. The indication of interest 306 for each corresponding merchant web data entry 302 may be a number (e.g., 5000 or 2000) or may be a percentage, such as a percentage based on the merchant's 114 bid relative to all bids on the associated interactive element 308 (e.g., 71.4% or 28.6%). Other factors suitable for consideration in determining the indication of interest 306 of a particular merchant 114 will be apparent to persons having skill in the relevant art, such as market share, reputation, consumer feedback, success rate, available inventory, delivery times and rates, etc.

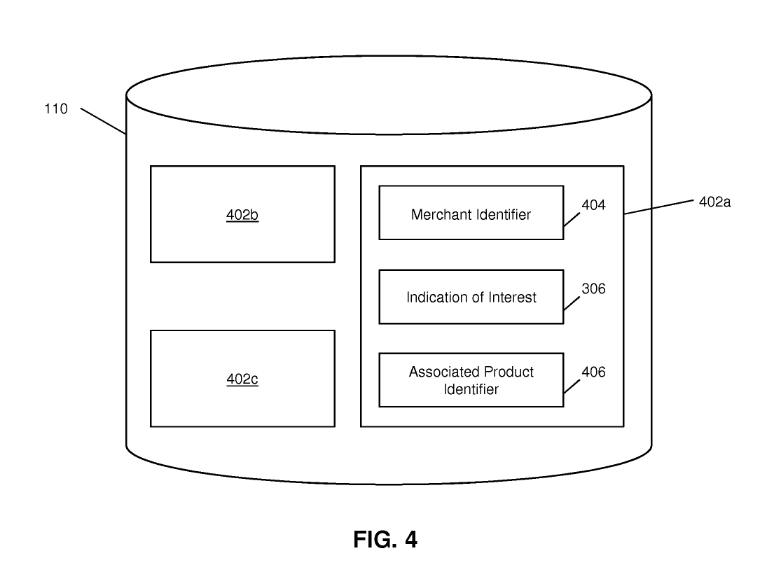

The merchant product database 110, as illustrated in FIG. 4, may include a plurality of merchant product data entries 402 (e.g., merchant product data entries 402a, 402b, and 402c as illustrated). Each merchant product data entry 402 may include a merchant identifier 404, the indication of interest 306, and an associated product identifier 406.

The merchant identifier 404 may be any identification value associated with a unique merchant (e.g., the merchant 114 of the merchants 112). In some embodiments, multiple merchant product data entries 402 may include a common merchant identifier 404 or common associated product identifier 406 but may not include two merchant product data entries 402 with the same merchant identifier 404 and associated product identifier 406 in each. Suitable types of identifiers for use as the merchant identifier 404 will be apparent to persons having skill in the relevant art.

The associated product identifier 406 may be an unique identification value associated with a product (e.g., a good, service, etc.) available for purchase on a web page (e.g., transmitting by the web page processing server 102 and displayed on the user apparatus 106). The product identifier 406 may be a universal product code (UPC), stock-keeping unit (SKU), manufacturer part number (MPN), European article number (EAN), international standard book number (ISBN), serial number, or any other value unique to the associated product.

In some embodiments, the associated product identifier 406 may be a value of an associated interactive element, such as the associated interactive element 308 illustrated in FIG. 3 and described above. For example, the associated product identifier 406 may be an identification value of an HTML button included on the displayed web page used to initiate a financial transaction for the corresponding product. It will be apparent to persons having skill in the relevant art that any unique identification may be used as the associate product identifier 406 such that the associated merchants 112 and corresponding indications of interest 306 can be organized for identifying upon the receipt of a user interaction with the corresponding interactive element and/or product available for purchase.

### Web Page Including Interactive Elements Connected to Multiple Merchants

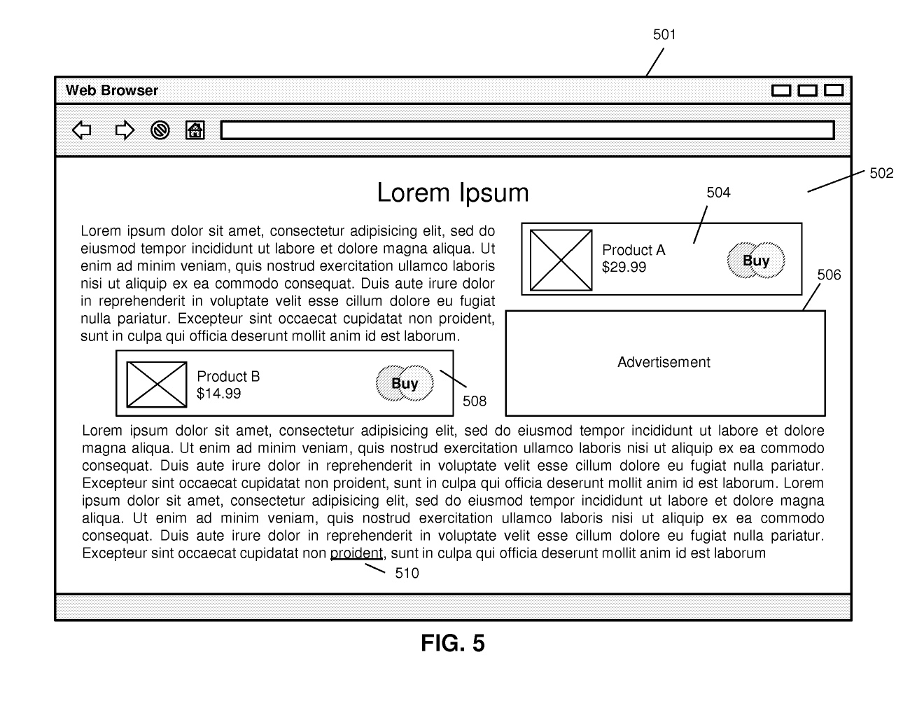

FIG. 5 illustrates a web page 502 that may be accessed via a web browser 501 (e.g., on the user apparatus 106). The web page 502 may be based on web page data transmitted to the user apparatus 106, such as by the transmitting unit 202 of the web page processing server 102 (e.g., and stored in the web page database 104).

The web page 502 may include a plurality of interactive elements with which a user may interact (e.g., using an input device included in the user apparatus 106, such as a mouse, stylus, or touch input device), such as an advertisement 506, a text hyperlink 510, or may include products available for purchase, such as products 504 and 508. Each product available for purchase may also include an interactive element, such as the “Buy” button included in each product 504 and 508 as illustrated in FIG. 5.

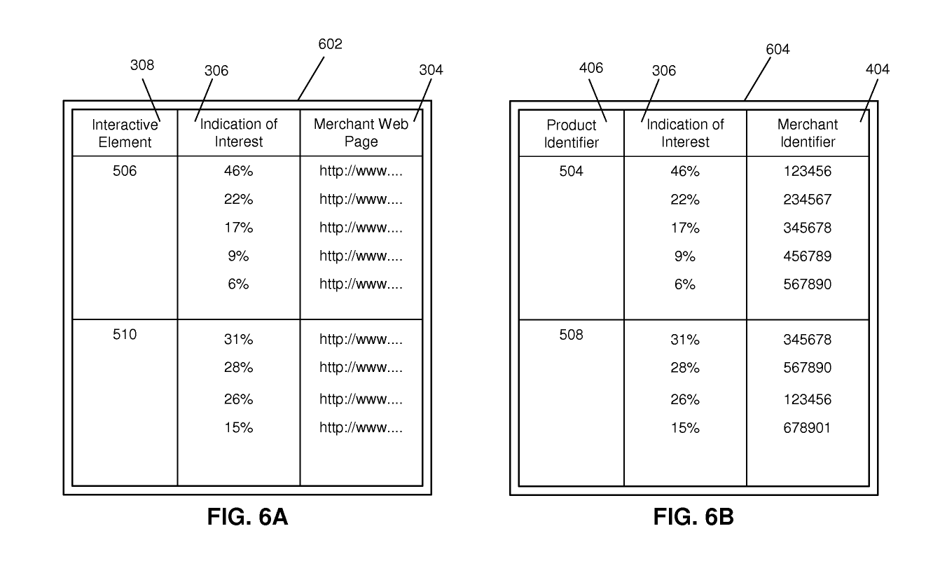

The merchant web database 108 may include merchant web data entries 302 for each interactive element in the web page 502 that may redirect the user apparatus 106 to a corresponding merchant web page 304, as illustrated in FIG. 6A. FIG. 6A shows a table 602 of merchant web data entries 302 corresponding to the web page 502. As illustrated in the table 602, the merchant web database 108 may include five merchant web data entries 302 that include the advertisement 506 as the associated interactive element 308, and may include four merchant data entries 302 that include the hyperlink 310 as the associated interactive element 308.

Once the web page processing server 102 has received an indication of a user interaction with one of the interactive elements 506 and 510, the processing unit 206 may identify a subset of the merchant web data entries 302, illustrated in the table 602, where the associated interactive element 308 corresponds to the indicated interactive element. For example if a user of the user apparatus 106 has clicked the advertisement 506, the processing unit 206 may identify the five merchant web data entries 302 that include the advertisement 506 as the associated interactive element 308. Once the subset has been identified, the processing unit 206 of the web page processing server 102 may identify a single merchant web data entry 302 based on the indication of interest 306 of each merchant web data entry 302 in the subset, as discussed previously.

For instance, in the present example, the processing unit 206 may identify the first merchant web data entry 302 associated with the advertisement 506 46% of the time, may identify the second merchant web data entry 302 22% of the time, etc. Additionally, the percentage might be used to indicate an order of selection, such that if the merchant having the highest percentage of other measure of interest is inappropriate for a particular transaction (e.g., due to lack of inventory, being unavailable, user de-section, etc.) then the user having the next highest indication of interest might be selected. Once a single merchant web data entry 302 has been identified, the processing unit 206 may cause the transmitting unit 202 to transmit an instruction to the user apparatus 106 redirecting the web browser 501 to display the corresponding merchant web page 304.

The merchant product database 110 of the web page processing server 102 may include a plurality of merchant product data entries 402 for each product available for purchase in the web page 502, such as the products 504 and 508, as illustrated in the table 604 of FIG. 6B. When a user initiates a financial transaction for one of the products, the processing unit 206 may identify a subset of the plurality of merchant product data entries 402 that include the associated product identifier 406. The processing unit 206 may identify a single merchant product data entry 402 based on the corresponding indications of interest 306, and may process the financial transaction between the user of the user apparatus 106 and the merchant corresponding to the merchant identifier 404 included in the identified merchant product data entry 402.

An advantage of the systems and methods disclosed herein is that the interactive elements in the web page 502, such as the advertisement 506, can be integrated into the web page 502 and maintained by the owner (e.g., webmaster) of the web page 502 to match the layout, color scheme, and aesthetic of the rest of the web page 502. Such integration may draw additional attention from users. In addition, the advertisement 506 could remain constant each time the web page 502 is displayed, and yet still be connected to multiple merchants, and thus be less distracting to users visiting the web page 502 and still provide traffic for each merchant.

### Method for Connecting Multiple Merchants to Interactive Elements in a Web Page

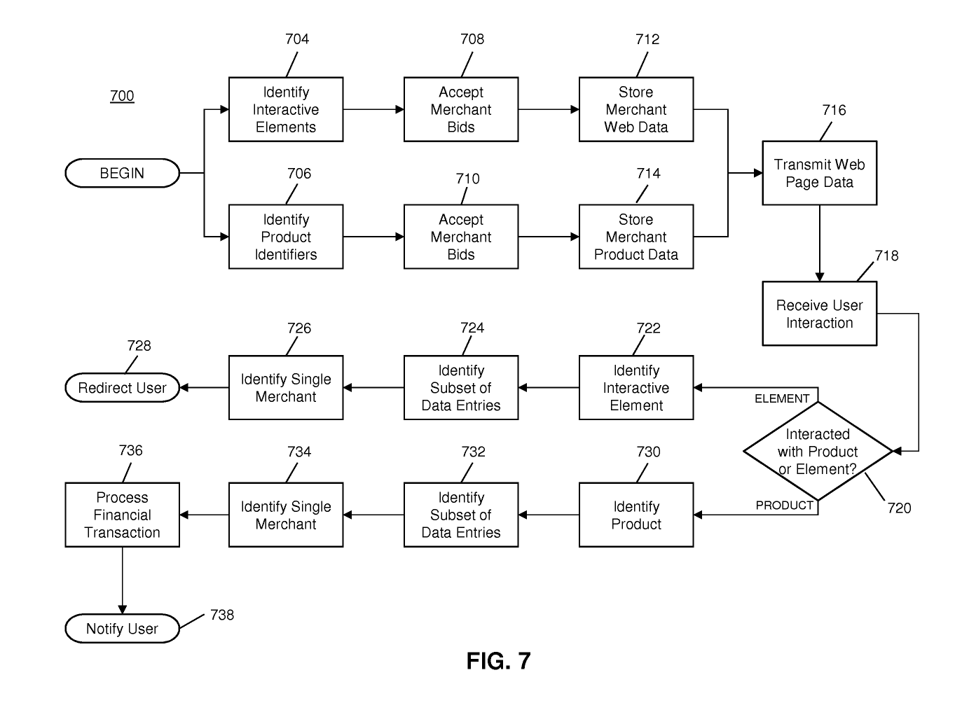

FIG. 7 illustrates a method 700 for connecting multiple merchants to interactive elements in a web page, such as the web page 502 of FIG. 5, discussed above.

In step 704, the processing unit 206 of the web page processing server 102 may identify interactive elements in a web page to be displayed (e.g., and stored in the web page database 104) on the user apparatus 106. Interactive elements may include images, hyperlinks, buttons, audio objects, video objects, animated elements (e.g., such as avatars), or any other element with which a user viewing the web page may interact. In step 706, the processing unit 206 may identify product identifiers corresponding to products available for purchase via the web page to be displayed.

In steps 708 and 710, the processing unit 206 (e.g., via the receiving unit 204) may accept bids from merchants on the identified interactive elements and product identifiers, respectively. In one embodiment, the merchant bids may be financial bids. In another embodiment, the merchant bids may be based on additional factors, including at least one of: consumer feedback, success rates, and reputation. The merchant bids accepted in step 708 may each include a merchant web page 304 to which an identified associated interactive element 308 should redirect. The merchant bids accepted in step 710 may each include a merchant identifier 404 (e.g., supplied by the merchant or identified by the web page processing server 102) and an associated product identifier 406.

In step 712, the processing unit 206 may store, in the merchant web database 108, merchant web data entries 302 for merchant bids accepted in step 708. In step 714, the processing unit 206 may store, in the merchant product database, merchant product data entries 402 for merchant bids accepted in step 710. Each of the merchant web data entries 302 and merchant product data entries 402 may include an indication of interest 306 indicating the interest the corresponding merchant has in being associated with the interactive element 308 and/or the product identifier 406. The indication of interest 306 may be based on the accepted merchant bid and may be represented by a number, a token, a grade, or indicia indicating the relative ranking of the corresponding merchant. In one embodiment, the indication of interest 306 may be represented by a percentage, cryptogram, or numerical value generated by an algorithm taking into consideration other factors.

In step 716, the transmitting unit 202 of the web page processing server 102 may transmit web page data corresponding to the web page (e.g., the web page 502) to the user apparatus 106. The user apparatus 106 may display the web page 502 (e.g., using the web browser 501). A user may view the web page 502 and may interact with one of the interactive elements or initiate a transaction for a product available for purchase on the web page 502. The user interaction may be transmitted by the user apparatus 106 to the web page processing server 102 where it may be received, by the receiving unit 204, in step 718.

At step 720, the processing unit 206 may analyze the received user interaction to determine if the interaction was with an interactive element for which the user apparatus 106 should be redirected or with a product available for purchase for which a financial transaction should be initiated. If the interaction was with an interactive element, then the method 700 may proceed to step 722, where the processing unit 206 may identify the interactive element with which the user interacted. Once the interactive element has been identified then, in step 724, the processing unit 206 may identify a subset of the merchant web data entries 302 in the merchant web database 108 where the associated interactive element 308 is the identified interactive element.

In step 726, the processing unit 206 may identify (e.g., select), in the subset of merchant web data entries 302, a single merchant web data entry 302 based on the indication of interest 306. Methods for selecting a single merchant web data entry 302 based on the indication of interest 306 will be apparent to persons having skill in the relevant art. Once the single merchant web data entry 302 has been identified, then, in step 728, the transmitting unit 202 may transmit redirecting web page data to the user apparatus 106 to redirect the web browser 501 to the merchant web page 304 including in the corresponding merchant web data entry 302.

If, in step 720, the user interaction was determined to be associated with a r product available for purchase, then the method 700 may proceed to step 730. In step 730, the processing unit 206 may identify the product available for purchase for which the indication was received. In one embodiment, identifying the available product may include identifying a product identifier 406. In step 732, the processing unit 206 may identify, in the merchant product database 110, a subset of merchant product data entries 402 that include the identified product identifier 406. Then, in step 734, the processing unit 206 may identify a single merchant product data entry 402 in the subset based on the indication of interest 306.

In step 736, the processing unit 206 may process a financial transaction between the user of the user apparatus 106 and a merchant (e.g., the merchant 114) corresponding to the merchant identifier 404 included in the identified single merchant product data entry 402. In some embodiments, processing the financial transaction may include transmitting an authorization request for the financial transaction to the financial transaction processing server 116, and receiving a response to the authorization request. Once the transaction has been processed, then, in step 738, the web page processing server 102 may notify the user of the user apparatus 106 and the merchant 114 of the results of the transaction processing.

### Exemplary Computer System Architecture

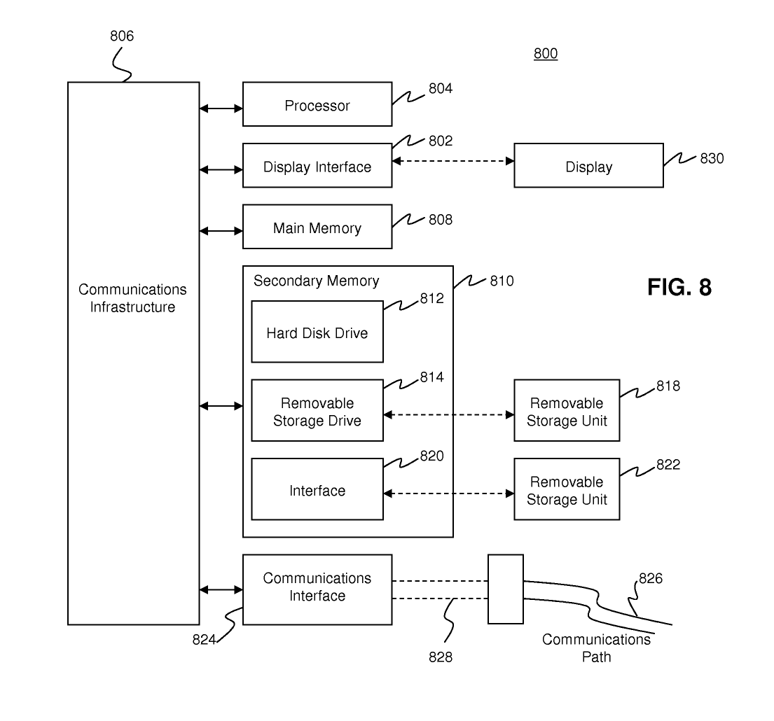

FIG. 8 illustrates a computer system 800 in which embodiments of the present disclosure, or portions thereof, may be implemented as computer-readable code. For example, the web page processing server 102, the user apparatus 106, the merchants 112, and the financial transaction processing server 116 of FIG. 1 may be implemented in the computer system 800 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 7, 9, and 10.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 818, a removable storage unit 822, and a hard disk installed in hard disk drive 812.

Various embodiments of the present disclosure are described in terms of this example computer system 800. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 804 may be a special purpose or a general purpose processor device. The processor device 804 may be connected to a communication infrastructure 806, such as a bus, message queue, network (e.g., the network 118), multi-core message-passing scheme, etc. The computer system 800 may also include a main memory 808 (e.g., random access memory, read-only memory, etc.), and may also include a secondary memory 810. The secondary memory 810 may include the hard disk drive 812 and a removable storage drive 814, such as a floppy disk drive, a magnetic tape drive, an optical disk drive, a flash memory, etc.

The removable storage drive 814 may read from and/or write to the removable storage unit 818 in a well-known manner. The removable storage unit 818 may include a removable storage media that may be read by and written to by the removable storage drive 814. For example, if the removable storage drive 814 is a floppy disk drive, the removable storage unit 818 may be a floppy disk. In one embodiment, the removable storage unit 818 may be non-transitory computer readable recording media.

In some embodiments, the secondary memory 810 may include alternative means for allowing computer programs or other instructions to be loaded into the computer system 800, for example, the removable storage unit 822 and an interface 820. Examples of such means may include a program cartridge and cartridge interface (e.g., as found in video game systems), a removable memory chip (e.g., EEPROM, PROM, etc.) and associated socket, and other removable storage units 822 and interfaces 820 as will be apparent to persons having skill in the relevant art.

The computer system 800 may also include a communications interface 824. The communications interface 824 may be configured to allow software and data to be transferred between the computer system 800 and external devices. Exemplary communications interfaces 824 may include a modem, a network interface (e.g., an Ethernet card), a communications port, a PCMCIA slot and card, etc. Software and data transferred via the communications interface 824 may be in the form of signals, which may be electronic, electromagnetic, optical, or other signals as will be apparent to persons having skill in the relevant art. The signals may travel via a communications path 826, which may be configured to carry the signals and may be implemented using wire, cable, fiber optics, a phone line, a cellular phone link, a radio frequency link, etc.

Computer program medium and computer usable medium may refer to memories, such as the main memory 808 and secondary memory 810, which may be memory semiconductors (e.g. DRAMs, etc.). These computer program products may be means for providing software to the computer system 800. Computer programs (e.g., computer control logic) may be stored in the main memory 808 and/or the secondary memory 810. Computer programs may also be received via the communications interface 824. Such computer programs, when executed, may enable computer system 800 to implement the present methods as discussed herein. In particular, the computer programs, when executed, may enable processor device 804 to implement the methods illustrated by FIGS. 7, 9, and 10, as discussed herein. Accordingly, such computer programs may represent controllers of the computer system 800. Where the present disclosure is implemented using software, the software may be stored in a computer program product and loaded into the computer system 800 using the removable storage drive 814, interface 820, and hard disk drive 812, or communications interface 824.

### Exemplary Method for Redirecting a User Apparatus to a Merchant Web Page

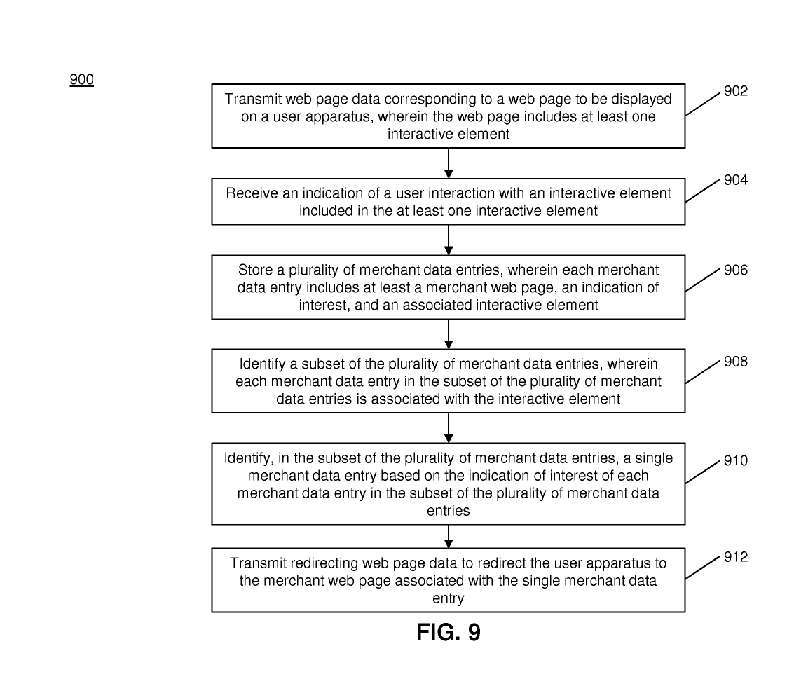

FIG. 9 illustrates a method 900 for redirecting a user apparatus (e.g., the user apparatus 106) to a merchant web page.

In step 902, a transmitting unit (e.g., the transmitting unit 202) may transmit web page data (e.g., stored in the web page database 104) corresponding to a web page to be displayed (e.g., the web page 502) on a user apparatus 106, wherein the web page 502 includes at least one interactive element. In one embodiment, the interactive element may be a hyperlink. In another embodiment, the interactive element may include digital content selected from a group consisting of images, audio files, image files, video files, and animated elements including avatars. In step 904, a receiving unit (e.g., the receiving unit 204) may receive an indication of a user interaction with an interactive element included in the at least one interactive element.

In step 906, a plurality of merchant data entries (e.g., merchant web data entries 302) may be stored (e.g., in the merchant web database 108), wherein each merchant data entry 302 includes at least a merchant web page (e.g., the merchant web page 304), an indication of interest (e.g., the indication of interest 306), and an associated interactive element (e.g., the associated interactive element 308). In some embodiments, the merchant data entry 302 may further include at least one of fulfillment information, inventory, pricing information, shipping information, and availability. In one embodiment, the indication of interest 306 may include at least one of a numerical value, token, grade, and indicia indicating the relative ranking of each merchant corresponding to each of the plurality of merchant data entries. In a further embodiment, the numerical value may be selected from one of a percentage, cryptogram, and a numerical value generated by an algorithm taking into consideration other factors. In some embodiments, the indication of interest 306 may be based on a financial bid of a merchant associated with the corresponding merchant web page 304, a merchant website, a community of web pages, product groupings by category, or product type or product grade.

In step 908, a processing unit (e.g., the processing unit 206) may identify a subset of the plurality of merchant data entries 302, wherein each merchant data entry 302 in the subset of the plurality of merchant data entries 302 is associated with the interactive element. Then, in step 910, the processing unit 206 may identify, in the subset of the plurality of merchant data entries 302, a single merchant data entry 302 based on the indication of interest 306 of each merchant data entry 302 in the subset of the plurality of merchant data entries. In step 912, the transmitting unit 202 may transmit redirecting web page data to redirect the user apparatus 106 to the merchant web page 304 associated with the single merchant data entry.

### Exemplary Method for Processing a Financial Transaction

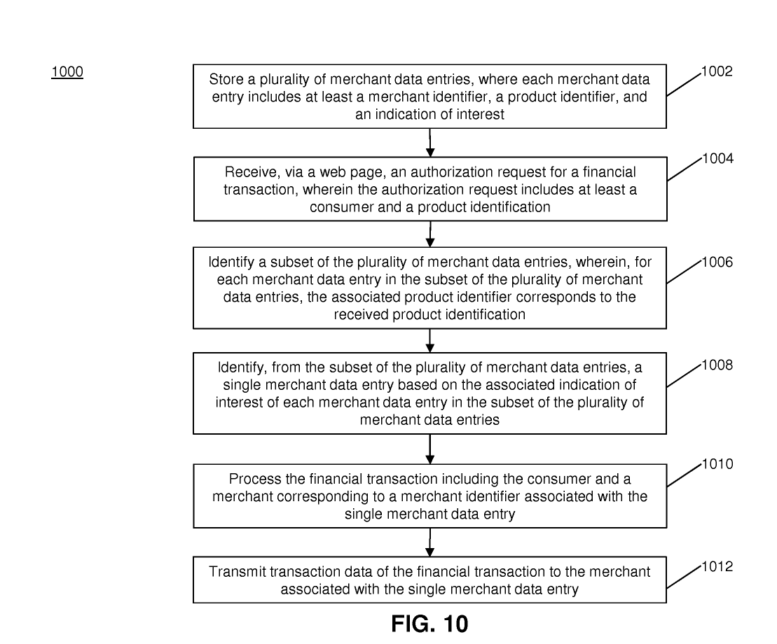

FIG. 10 illustrates a method 1000 for processing a financial transaction.

In step 1002, a plurality of merchant data entries (e.g., merchant product data entries 402) may be stored (e.g., in the merchant product database 110), where each merchant data entry 402 includes at least a merchant identifier (e.g., the merchant identifier 404), a product identifier (e.g., the associated product identifier 406), and an indication of interest (e.g., the indication of interest 306). In some embodiments, the merchant data entry 302 may further include at least one of fulfillment information, inventory, pricing information, shipping information, and availability. In one embodiment, the indication of interest 306 may include at least one of a numerical value, token, grade, and indicia indicating the relative ranking of each merchant corresponding to each of the plurality of merchant data entries. In a further embodiment, the indication of interest 306 may be selected from one of a percentage, a cryptogram, and a numerical value generated by an algorithm taking into consideration other factors. In some embodiments, the indication of interest 306 may be based on a financial bid of a merchant (e.g., the merchant 114) corresponding to the merchant identifier 404 included in the corresponding merchant data entry 402. In a further embodiment, the indication of interest 306 may be a measurement of the financial bid of the merchant 114 compared to the financial bids of other merchants (e.g., the merchants 112) corresponding to other merchant data entries in the subset of the plurality of merchant data entries 402.

In step 1004, a receiving unit (e.g., the receiving unit 204) may receive an authorization request for a financial transaction, wherein the authorization request includes at least a consumer (e.g., of the user apparatus 106) and a product identification. In one embodiment, the product identification may be one of: a universal product code (UPC), stock-keeping unit (SKU), manufacturer part number (MPN), serial number, European article number (EAN), and an international standard book number (ISBN). In step 1006, a processing unit (e.g., the processing unit 206) may identify a subset of the plurality of merchant data entries 402, wherein, for each merchant data entry 402 in the subset of the plurality of merchant data entries 402, the associated product identifier 406 corresponds to the received product identification.

In step 1008, the processing unit 206 may identify, from the subset of the plurality of merchant data entries 402, a single merchant data entry 402 based on the associated indication of interest 306 of each merchant data entry 402 in the subset of the plurality of merchant data entries 402. Once the single merchant data entry 402 has been identified, then, in step 1010, the processing unit 206 may process the financial transaction including the consumer and a merchant (e.g., the merchant 114) corresponding to the merchant identifier 404 associated with the single merchant data entry 402. In step 1012, the transmitting unit 202 may transmit transaction data of the financial transaction to the merchant 114 associated with the single merchant data entry 402.

Techniques consistent with the present disclosure provide, among other features, systems and methods for connecting multiple merchants to interactive elements in a web page including the redirecting of user apparatuses and processing of financial transactions. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for processing a financial transaction, comprising:
storing, in a database, a plurality of merchant data entries, where each merchant data entry includes at least a merchant identifier, a product identifier, and an indication of interest;
receiving, via a web page, an authorization request for a financial transaction, wherein the authorization request includes at least a consumer and a product identification;
identifying, in the database, a subset of the plurality of merchant data entries, wherein, for each merchant data entry in the subset of the plurality of merchant data entries, the associated product identifier corresponds to the received product identification;
identifying, from the subset of the plurality of merchant data entries, a single merchant data entry based on the associated indication of interest of each merchant data entry in the subset of the plurality of merchant data entries;
processing, by a processor, the financial transaction including the consumer and a merchant corresponding to a merchant identifier associated with the single merchant data entry; and
transmitting, by a transmitter device, transaction data of the financial transaction to the merchant associated with the single merchant data entry.

2. The method of claim 1, wherein the indication of interest includes at least one of a numerical value, token, grade, and indicia indicating of the relative ranking of each merchant corresponding to each of the plurality of merchant data entries.

3. The method of claim 1, wherein the numerical value is selected from one of a percentage, numerical value generated by an algorithm taking into consideration other factors, and a cryptogram.

4. The method of claim 1, wherein the indication of interest is based on a financial bid of a merchant associated with a merchant identifier included in the corresponding merchant data entry.

5. The method of claim 4, wherein the indication of interest is a measurement of the financial bid of the merchant compared to the financial bids of other merchants corresponding to other merchant data entries in the subset of the plurality of merchant data entries.

6. The method of claim 4, wherein each merchant data entry of the plurality of merchant data entries further includes at least one of fulfillment information, inventory, pricing information, shipping information, and availability.

7. A system for processing a financial transaction, comprising:
a database configured to store a plurality of merchant data entries, where each merchant data entry includes at least a merchant identifier, a product identifier, and an indication of interest;
a receiver device configured to receive, via a web page, an authorization request for a financial transaction, wherein the authorization request includes at least a consumer and a product identification;
a processor configured to
identify, in the database, a subset of the plurality of merchant data entries, wherein, for each merchant data entry in the subset of the plurality of merchant data entries, the associated product identifier corresponds to the received product identification,
identify, from the subset of the plurality of merchant data entries, a single merchant data entry based on the associated indication of interest of each merchant data entry in the subset of the plurality of merchant data entries, and
process the financial transaction including the consumer and a merchant corresponding to a merchant identifier associated with the single merchant data entry; and
a transmitter device configured to transmit transaction data of the financial transaction to the merchant associated with the single merchant data entry.

8. The system of claim 7, wherein the indication of interest includes at least one of a numerical value, token, grade, and indicia indicating the relative ranking of each merchant corresponding to each of the plurality of merchant data entries.

9. The system of claim 8, wherein the indication of interest includes at least one numerical value and the at least one numerical value is selected from one of a percentage, numerical value generated by an algorithm taking into consideration other factors, and a cryptogram.

10. The system of claim 7, wherein the indication of interest is based on a financial bid of a merchant corresponding to the merchant identifier included in the corresponding merchant data entry.

11. The system of claim 10, wherein the indication of interest is a measurement of the financial bid of the merchant compared to the financial bids of other merchants corresponding to other merchant data entries in the subset of the plurality of merchant data entries.

12. The system of claim 7, wherein each merchant data entry of the plurality of merchant data entries further includes at least one of fulfillment information, inventory, pricing information, shipping information, and availability.
